(19) United States
(12) Patent Application Publication
(10) Pub. No.: US 2009/0084638 A1
(43) Pub. Date: Apr. 2, 2009

(54) Disc brake pad with visual wear indicator

(76) Inventor: Steven J. Masterson, Margate, FL (US)

Correspondence Address: Warn Partners, P.C., P.O. Box 70098, Rochester Hills, MI, 48307, US

(21) Appl. No.: 12/284,678

(22) Filed: Sep. 24, 2008

Related U.S. Application Data
(63) Continuation of application No. 11/737,356, filed on Apr. 19, 2007, now abandoned.
Application No. 11/737,356 is a continuation-in-part of application No. 11/026,899, filed on Dec. 30, 2004, now abandoned.

(51) Int. Cl. F16D 66/02

(52) U.S. Cl. 188/1.11 W

(57) ABSTRACT

A disc brake pad having a visual indicator of brake wear to eliminate the current necessity of dismantling related parts for brake pad inspection by an automobile mechanic. The improved brake pad uses an existing conventional brake pad friction material having a recess cut into a rear surface of the friction material where the friction material is connected to the brake pad backing. This recess is filled with one or more layers of a brightly-colored visual indicator dye or dyes. As the friction material is worn sway by contact with the brake rotor, the thickness of the friction material is reduced until, eventually, the visual indicator becomes exposed at a predetermined depth. The visual indicator dye is pulverized and discharged onto the exterior surface of the wheel rim as colored brake dust. The presence of the colored brake dust alerts the driver of the need for brake pad replacement.

### BACKGROUND OF THE INVENTION

1. Field of the Invention

This invention relates to an article of manufacture comprised of an improved automobile disc brake pad having a visual brake wear indicator that is readily visible.

2. Description of Related Art

Visual confirmation of automobile brake wear is a problem faced every day by countless drivers. Currently, automobile mechanics are required to perform a close and time-consuming inspection to ascertain whether brake wear has reached a level warranting replacement of die brake pad. Oilier related parts of an automobile must be dismantled in order to inspect the brake pads. Due to the numerous factors that can affect the life of a brake pad, most vehicle manufacturers recommend periodic inspections of the brake components. Thus, the current method of inspecting brake pads for wear is less efficient and more expensive than it otherwise could be if automobile mechanic inspections and parts disassembly were not required.

A search of the prior art reveals patents that describe brake pads having a visual indicator of brake wear. In U.S. Pat. No. 5,511,636, issued to Tanaka on Apr. 30, 1996, a drum brake device is described wherein a colored strip is located on at least one side of the brake lining that can be visually examined through an inspection hole bored in the backplate to determine the extent of brake wear. In that invention, the colored strip is consumed along with the wear of the lining so that when the colored strip is no longer visible, i.e. it has been worn away completely, the individual will know that the brake shoe must be replaced. However, drum brakes have largely been replaced with the use of disc brakes that can absorb more heat than a drum brake assembly.

U.S. Pat. No. 6,457,566, issued to Toby on Oct. 1, 2002, describes a disc brake rotor with a visual indicator on a brake contact surface of the rotor within a brake pad contact region. This visual indicator is described as a counterbore, groove, or other recessed surface substantially parallel to the brake contact surfaces at a depth such that the thickness of the annular disc below the recessed surface corresponds to or is greater than a predetermined minimum useable thickness of the annular disc. The recessed surface can be painted a bright color to. increase its visibility. U.S. Pat. No. 6,279,698, issued to Oberti on Aug. 28, 2001, also describes a brake disc with visual wear control wherein the depth of grooves on the braking surface of a brake disc is not greater than the maximum wear level allowed on each face of the brake disc. Thus, when the depth of the grooves becomes very reduced, the brake disc is worn, and when the grooves disappear or become nearly invisible, the brake disc has reached its maximum wear limit and must be replaced. These two patents describe visual wear indicators for the brake disc, but not for the brake pads that contact the brake disc.

U.S. Pat. No. 995,067, issued to Jones, on Jun. 13, 1911, describes a brake shoe having a supporting member with a plurality of recesses or pockets into which inserts are placed. The inserts are constructed not of visual indicator dye, but of fire clay, ground slag, asbestos, plumbago, or similar substances that are selected to provide maximum braking and, if desired, a minimum amount of lubricating action. Unlike the components of the present invention, the inserts of Jones are not intended to provide a visual indicator of brake wear and the need for brake replacement.

United Kingdom Patent Application No. GB 2047827 A, filed by Stoker et al., on Jan. 21, 1980, describes an automobile brake pad having an inner layer with a distinctive color. Once the outer layer of the Stoker brake pad wears away after use, the inner layer also begins to wear and produces a colorful brake pad dust that is deposited on the outer surface of the wheel of the automobile. The Stoker invention uses an inorganic pigment, preferably, iron oxide, to form the thinner inner layer. The Stoker reference describes a bi-layer brake pad and does not disclose the several means for holding dye described by the present application.

The prior art patents described above do not provide effective solutions to the inefficiency and high costs involved in current inspections for wear on disc brake pads. Often, related parts must be dismantled to inspect the disc brake pads, which normally requires paying a mechanic to perform an inspection. The present invention provides a readily visible brake wear indicator that the average automobile driver can quickly and easily identify.

### SUMMARY OF THE INVENTION

This inventions described herein relate to a disc brake pad for braking a vehicle and for providing a visual indicator of brake wear and the need for disc brake pad replacement without the necessity of dismantling related parts and without the need for inspection by an automobile mechanic. The improved disc brake pad is formed by cutting or otherwise forming a recess or other means for holding a visual indicator dye within one side of a conventional disc brake pad. Preferably, the recess is cut into the side of friction material of the brake pad that does not contact the brake rotor but which does contact the metal brake pad backing. At least one highly visible, colored visual indicator dye is deposited within the recess of the brake pad friction material of which said disc brake pad is constructed. Alternatively, two layers of friction material may be fused into one piece to form the disc brake pad.

As friction between the brake pad and the brake rotor wears away the friction material, the thickness of the friction material is reduced. Once the friction material of the brake pad is worn away to a predetermined depth, the visual indicator dye deposited within the recess therein is exposed. Contact between the brake rotor and the friction material also results in contact between said brake rotor and said visual indicator dye. As subsequent brake use creates friction on the surface of the friction material and visual indicator dye deposited therein, said brightly-colored visual indicator dye is pulverized and discharged onto the exterior surface of the wheel rim as colored brake dust. The presence of the brightly-colored brake dust alerts the driver of the need for brake pad replacement.

An object of this invention is to provide a visual indicator of brake wear so that the driver may know when to replace an automobile's brake pads without the need for a brake inspection wherein related parts are dismantled.

Another object of this invention is to provide a visual indicator that can be seen when looking at the exterior rim of the vehicle rather than requiring a “behind-the-wheel” inspection of the brake pad by the driver or by a mechanic

Still another object of this invention is to provide a visual indicator of the degree of brake wear that has occurred to a brake pad.

Yet another object of this invention is to provide a visual indicator of brake wear that may be used with existing brake pads so as to reduce production costs.

In accordance with these and other objects which will become apparent hereinafter, the instant invention will now be described with particular reference to the accompanying drawings.

### BRIEF DESCRIPTION OF THE DRAWINGS

FIG. 1 shows a schematic side elevational view of the improved brake pad having a rectangular recess cut into the rear surface of the friction material and filled with a single layer of visual indicator dye.

FIG. 2 shows a side elevational view of the improved disc brake pad and disc brake assembly in operation.

FIG. 3 shows a side view of an automobile with visual indicator dust deposited on the wheel rim.

FIG. 4A shows a schematic side elevational view of the brake pad having a groove containing visual indicator dye cut into the rear surface of the friction material at the interface between said friction material and the brake pad backing.

FIG. 4B shows a schematic side elevational view of the brake pad having a rivet containing visual indicator dye incorporated into the rear surface of the friction material.

FIG. 4C shows a schematic side elevational view of the brake pad including a dome of several layers of varying colors of visual indicator dye deposited within a recess cut into the rear surface of the friction material with the base of the dome being proximal to the interface between the rear surface of said friction material and the brake pad backing.

FIG. 5 shows a schematic side elevational view of the brake pad having fused first and second layers of friction material with a source of visual indicator dye present within a groove cut into said second layer of friction material on the front surface where said second layer is connected and fused to said first layer.

### DETAILED DESCRIPTION

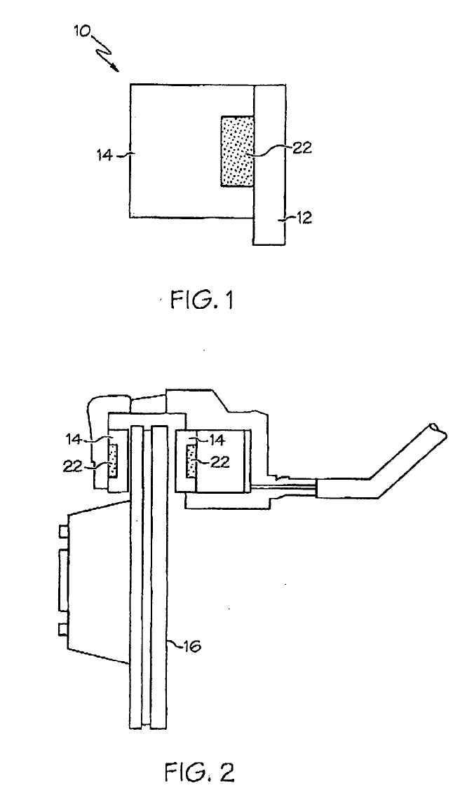

FIGS. 1 and 2 illustrate an improved disc brake pad 10 comprising a single layer of friction material 14 and a source of visual indicator material 22. The improved disc brake pad 10 provides a visual alert and prompt that the brake pad's friction material 14 has worn away to such an extent that the brake pad will soon become unsafe for driving and possibly prone to brake failure. The source of visual indicator material 22 may include one or more layers of a visual indicator material or materials capable of forming a colored dust 32. In the preferred embodiment of the improved disc brake pad 10, the visual indicator material 22 comprises a thermally-stable, heat-resistant dye, however, other heat-resistant materials capable of forming a colored brake pad dust may also be used. Alternative visual indicator materials may include any suitable thermally-stable, heat-resistant, color-producing, erodable material such as metals, metal alloys, clays, artificial polymers, and heat-resistant organic compounds. For convenience, the visual indicator material 22 will be referred to herein as visual indicator dye, or simply, as dye 22 although the inventor contemplates the use of alternative colored dust-producing materials. When multiple layers 22a of dye 22 are deposited within the friction material, each layer 22a of dye is a different, bright, visually-distinctive color. Preferably, the visual indicator dye 22 is bright yellow so as to be clearly visible when eroded and deposited as colored brake dust on the wheel or wheel run of an automobile. In this manner, the improved disc brake pad 10 alerts the user to the necessity of replacing the brake pad after excessive wear. Said visual indicator dye 22 is located at a predetermined depth within the friction material 14.

The predetermined depth of the visual indicator dye 22 within the friction material 14 is a maximum usable depth of said brake pad friction material as measured from a front surface 14a of said friction material that contacts a brake rotor 16. The maximum usable depth of the friction material 14 is the depth at which a user may continue to operate the automobile safely for a predetermined period of time but should replace said brake pad 10 as soon as possible to avoid brake failure.

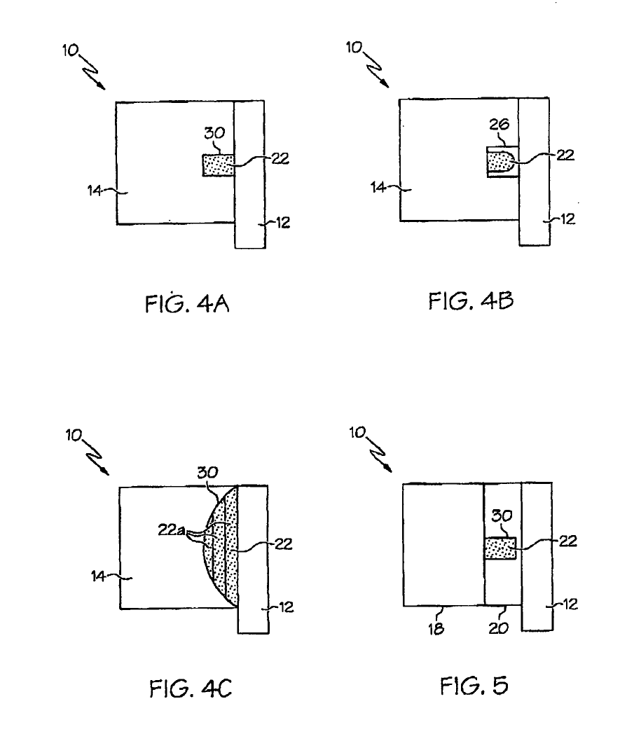

The brake pad 10 may be comprised of one or more layers of friction material 14. In the preferred embodiment shown in FIGS. 1 and 4A, only a single layer of friction material 14 is used to form the brake pad 10 so that conventional disc brake pads may be adapted for use with the visual indicator dye 22, thereby reducing manufacturing costs. The improved brake pad 10 preferably uses an existing conventional brake pad friction material 14 having a recess cut into a rear surface 14b of the friction material where the friction material is connected to the brake pad backing 12. The friction material 14 is manufactured from a low-density metallic or semi-metallic substance that is designed to wear away as a result of the friction the brake pad 10 experiences at a surface where it contacts the brake rotor 16 when a driver depresses the brake pedal. The friction material 14 of the brake pad 10 comprises the front surface 14a for contacting the brake rotor 16 and a rear surface 14b of connecting to a brake pad backing 12. Where multiple layers of friction material 14 are fused to form the brake pad 10, at least one of the layers of friction material includes a source of one or more colored visual indicator dyes 22 capable of forming the colored dust 32 that is emitted onto the wheel rim 24 of the automobile when the brake pad requires replacement. FIG. 2 illustrates the disc brake pad 10 in operation as it contacts the brake rotor 16.

The visual indicator dye 22 is securely affixed to or within the friction material 14 of the brake pad 10, preferably, by depositing the dye within one or more recesses 30 cut into the rear surface 14b of said friction material. Locating the recess 30 on the rear surface 14b of the friction material 14 permits easy installation of the dye 22 within said recess before the friction material is attached to the brake pad backing 12 and also allows the visual indicator dye to be easily positioned at a predetermined maximum usable depth within the friction material. As illustrated in FIGS. 1 and 4C, the recess 30 may be conical, hemispherical, dome-shaped, polygonal, or irregular in shape when viewed in cross-section. The recess 30 may also be constructed as one or more grooves 30 cut into the rear surface 14b of the friction material 14 into which said visual indicator dye 22 may be deposited, as shown in FIG. 4A. Although said recess or recesses 30 are preferably cut into the rear surface 14b of the friction material 14 where said friction material contacts the brake pad backing 12, the recess may also be cut into the front surface 14a of the friction material or into any side surface of said friction material.

In an alternate embodiment illustrated in FIG. 4B, the visual indicator dye 22 is deposited within one or more soft rivets 26 embedded in the friction material 14. Preferably, the rivets 26 are embedded within the rear surface 14b of the friction material 14 for easily installation of the dye 22 within said rivets. The rivets 26 are constructed from a material sufficiently soft so as to be eroded away by frictional contact with the brake rotor 16, thereby also eroding and releasing the visual indicator dye 22 as colored brake dust 32 deposited onto the exterior surface of the automobile tire or wheel rim 24.

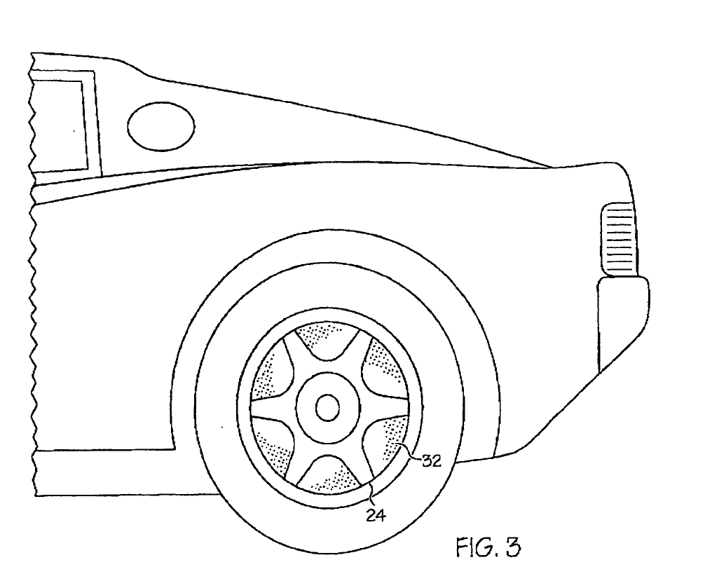

One or more layers of dye 22 are deposited within the recess 30 or rivet 26 of the friction material 14. The dye 22 forms a generally solid block of dye within the recess 30 or rivet 26 and becomes firmly attached to the surface of the recess or rivet wall. When the visual indicator dye 22 deposited within the recess 30 or rivet 26 of the friction material solidifies, the solid block of dye preferably corresponds both geometrically and dimensionally to the shape and size of the space in the brake pad within which said dye is deposited. Once the front surface 14a of the friction material 14 is worn to a predetermined usable depth, the visual indicator dye 22 within said friction material is exposed. As the friction material 14 is worn away by usage of the brakes which causes said friction material to contact the brake rotor 16, the depth of friction material on the front surface 14a of the brake pad is reduced, and eventually, the visual indicator dye 22 is exposed. Frictional contact between the brake rotor 16 and the exposed visual indicator dye 22 easily pulverizes and erodes the dye to create the brightly colored brake, dust 32 discharged from the brake assembly onto the wheel or wheel rim 24 as illustrated in FIG. 3. By using several layers 22a of visual indicator dye 22, with each of said layers 22a having a different, bright and visually-distinctive color, the dust 32 emitted onto the surface of the wheel or wheel rim 24 changes in color according to the depth to which the brake pad friction material 14 has been eroded by contact with the brake rotor 16. In this way, the user receives a visual cue concerning the degree of brake pad wear so that said user may estimate the remaining “life” of the brake pad for safe use in braking the vehicle.

Preferably, the visual indicator dye 22 is bright yellow for maximum visibility to the driver, although other distinctive colors, including orange, red, white, blue, pink, and green, may also be used. In the preferred embodiment, said visual indicator dye is thermally stable and resistant to breakdown and color loss at high temperatures. The visual indicator dye is also nontoxic and washes off of surfaces easily without staining. In addition, while the friction material 14 in the preferred embodiment is constructed from a metal alloy, other friction materials could also be used, such as ceramics or organic substances including wood and nylon.

The improved brake pad 10 is preferably installed and used for braking automobiles, including cars, trucks, tractor trailers, and buses, however, said brake pad may also be constructed for use with bicycles, motorcycles, trolleys, streetcars, trains, and other transportation devices that require brakes. Said brake pad 10 may also be used as a damper to prevent movement of an object, such as a building. In each instance, the visual indicator dye is emitted as colored dust that permits an estimation of the extent of wear to the friction material.

FIG. 5 illustrates an alternate embodiment of the disc brake pad 10 comprising a high-density metal alloy brake pad backing 12 to which a fused bilayer of a friction material 14 is bonded. The friction material 14 of said brake pad 10 is comprised of a first layer 18 of ordinary friction material 14, and a second layer 20 of friction material 14 which has a visual indicator dye 22 intermixed throughout. The first and second layers 18 20, which form the fused bilayer of friction material 14, are bonded to the metal brake pad backing 12. The two layers 18, 20 of friction material 14 are fused together into one disc brake pad 10.

As the first layer 18 of friction material 14 is worn away by usage of the brakes which causes said first layer 18 to contact the brake rotor 16, the depth of friction material in the first layer is reduced. Once the first layer 18 of friction material 14 is completely worn away, the second layer 20 of friction material 14, which contains the visual indicator dye 22, is exposed. As the second layer 20 of the brake pad 10 contacts the surface of the brake rotor 16, the resulting friction begins to wear away said second layer 20 and its intermixed dye 22, which results in a discharge of a brightly-colored brake pad dust 22. As shown in FIG. 3, the dust 22, which results from the wearing away of the dye 22 intermixed in the second layer 20 of friction material 14, is deposited, in part, onto the wheel rim 24 just as normal brake dust is deposited thereon when other disc brake pads are used. The presence of the brightly-colored visual indicator dust 22 on the exterior surface of the wheel rim 24 alerts the driver that the vehicle's brake pads 10 are worn and need to be replaced.

In an alternate embodiment of the fused bilayer brake pad, the disc brake pad comprises a first layer of friction material fused to a second layer of friction material that contains a groove etched into the surface at which said second layer is fused to the first layer of friction material. Before the two layers are fused, this groove is filled with a brightly-colored visual indicator dye that solidifies within the recess of the groove. Thereafter, the two layers of friction material are fused into one piece, a disc, brake pad. Once friction wears away the first layer of friction material, the groove filled with visual indicator dye becomes exposed. The visual indicator dye is pulverized by friction created by the brake pad contacting the brake rotor and is released as colored brake dust onto the vehicle's wheel rim. Alternatively, the groove 26 may be etched into the surface at which said second layer is attached to the brake pad backing 12, as shown in FIG. 5.

In another embodiment of the fused bilayer brake pad, the disc brake pad comprises a first layer of friction material fused to a second layer of friction material, wherein said second layer of friction material includes a soft metallic rivet with an interior hollow space for holding a visual indicator dye. As friction wears sway the first layer of friction material, said second layer of friction material and said rivet become exposed to the contact friction with the brake rotor. The material from which the rivet is constructed is sufficiently soft to erode along with the brake pad friction material, without damaging the brake rotor, so that the visual indicator dye is released along with the brake dust onto the vehicle's wheel rim.

In still another embodiment of the fused bilayer brake pad, the disc brake pad comprises a first layer of friction material fused to a second layer of friction material, wherein said second layer of friction material contains a cone or dome of visual indicator dye 22 deposited within a cone or dome-shaped recess 30 that extends from the interface surface of the second layer on the brake pad backing to or near the surface of the second layer of friction material where said second layer interfaces with the first layer of friction material. In this embodiment, once the first layer of friction material is worn away, thereby exposing the second layer of friction material, the visual indicator dye is pulverized in small amounts and released with brake dust onto the vehicle's wheel rim. As the second layer of friction material is eroded to gradually greater depths, the amount of visual indicator dye pulverized and released onto the wheel rim increases due to the dome or cone shape of the dye formation included within said second layer.

The instant invention has been shown and described herein in what is considered to be the most practical and preferred embodiment. It is recognized, however, that departures may be made therefrom within the scope of the invention and that obvious modifications will occur to a person skilled in the art.

1-20. (canceled)

21. A disc brake pad for a motor vehicle, comprising,
a layer of friction material having a front wear surface for contacting a brake rotor and a rear surface connected to a brake bad backing;
one or more recesses formed into said rear surface; and
one or more colored visual indicator dyes located within said one or more recesses;
wherein said one or more colored visual indicator dyes is located at a predetermined maximum usable depth from said front wear surface so that a colored brake dust is emitted onto an outside surface of a wheel rim to alert a user as said disc brake pad is wearing.

22. The disc brake pad for a motor vehicle of claim 21, wherein said one or more colored visual indicator dyes is formed of a plurality of layers of dye, wherein each layer is a different color so that different colored brake dust is emitted to alert said user as said disc brake pad is wearing and alert said user when said disc brake pad needs replacement.

23. The disc brake pad for a motor vehicle of claim 21, wherein said one or more recesses is formed as grooves cut into said rear surface.

24. The disc brake pad for a motor vehicle of claim 21, wherein said layer of friction material further comprises a first layer fused to a second layer, wherein said first layer has said front wear surface and said second layer has said rear surface.

25. The disc brake pad for a motor vehicle of claim 21, further comprising one or more rivets embedded within said rear surface, wherein said one or more colored visual indicator dyes are located within said one or more rivets and said one or more rivets are formed of a material so as to be eroded away by frictional contact with said brake rotor, thereby releasing said one or more colored visual indicator dyes as said colored brake dust.

26. The disc brake pad for a motor vehicle of claim 21, further comprising one or more rivets embedded within said one or more recesses, said one or more rivets having a plurality of layers of dye of different colors, wherein said one or more rivets are formed of a material so as to be eroded away by frictional contact with said brake rotor, thereby releasing said plurality of layers of dye so that different colored brake dust is emitted onto said wheel rim.

27. The disc brake pad for a motor vehicle of claim 21, wherein said one or more recesses is formed as a substantially dome-shaped recess located at a predetermined maximum usable depth from said front wear surface and having a wider base located on said rear surface, wherein an amount of said colored brake dust emitted increases as the disc brake pad is wearing.

28. The disc brake pad for a motor vehicle of claim 21, wherein said one or more recesses is formed as a substantially dome-shaped recess located at a predetermined maximum usable depth from said front wear surface and having a wider base located on said rear surface, wherein a plurality of layers of dye each having a different color is located within said dome-shaped recess so that different colored brake dust is emitted and an amount of said colored brake dust emitted increases as the disc brake pad is wearing.

29. The disc brake pad for a motor vehicle of claim 21, wherein said one or more recesses is formed in a shape from the group consisting of dome-shaped, conical shape, hemispherical shape, and polygonal shape.

30. A disc brake pad for a motor vehicle, comprising,
at least one layer of friction material having a front wear surface for contacting a brake rotor and a rear surface connected to a brake bad backing;
one or more recesses formed into said rear surface; and
one or more colored visual indicator dyes located within said one or more recesses, said one or more colored visual indicator dyes each formed of a plurality of layers of dye, wherein each layer is a different color; and
wherein said one or more colored visual indicator dyes is located at a predetermined maximum usable depth from said front wear surface so that a colored brake dust is emitted from each layer onto an outside surface of a wheel rim to alert a user as said disc brake pad is wearing.

31. The disc brake pad for a motor vehicle of claim 30, wherein said at least one layer of friction material further comprises a first layer fused to a second layer, wherein said first layer has said front wear surface and said second layer has said rear surface.

32. The disc brake pad for a motor vehicle of claim 30, wherein said one or more recesses is formed as grooves cut into said rear surface.

33. The disc brake pad for a motor vehicle of claim 30, further comprising one or more rivets embedded within said one or more recesses, wherein said one or more colored visual indicator dyes are located within said one or more rivets and said one or more rivets are formed of a material so as to be eroded away by frictional contact with said brake rotor, thereby releasing said one or more colored visual indicator dyes as said colored brake dust.

34. The disc brake pad for a motor vehicle of claim 30, wherein said one or more recesses is formed as a substantially dome-shaped recess located at a predetermined maximum usable depth from said front wear surface and having a wider base located on said rear surface, wherein an amount of said colored brake dust emitted increases as the disc brake pad is wearing.

35. The disc brake pad for a motor vehicle of claim 30, wherein said one or more recesses is formed in a shape from the group consisting of dome-shaped, conical shape, hemispherical shape, and polygonal shape.

36. A disc brake pad for a motor vehicle, comprising,
at least one layer of friction material having a front wear surface for contacting a brake rotor and a rear surface connected to a brake bad backing;
a substantially dome-shaped recess located at a predetermined maximum usable depth from said front wear surface and having a wider base located on said rear surface;
a plurality of layers of dye each having a different color located within said dome shaped recess;
wherein an amount of colored brake dust emitted from said plurality of layers of dye in said dome-shaped recess onto an outside surface of a wheel rim increases to alert a user as said at least one layer of friction material of said disc brake pad is wearing.

37. The disc brake pad for a motor vehicle of claim 36, wherein said at least one layer of friction material further comprises a first layer fused to a second layer, wherein said first layer has said front wear surface and said second layer has said rear surface.

38. The disc brake pad for a motor vehicle of claim 36, wherein said at least one layer of friction material further comprises a first layer fused to a second layer, said first layer having said front wear surface and said second layer having said rear surface, wherein said dome-shaped recess extends from said rear surface substantially to where said second layer interfaces with said first layer.

39. The disc brake pad for a motor vehicle of claim 36, wherein said plurality of layers of dye is thermally stable and resistant to breakdown and color loss at high temperatures.

40. The disc brake pad for a motor vehicle of claim 36, wherein each layer of said plurality of layers of dye comprises a visually-distinctive dye that is brightly colored.
